(19) United States
(12) Patent Application Publication
(10) Pub. No.: US 2023/0245360 A1
(43) Pub. Date: Aug. 3, 2023

(54) Microscopy System and Method for Editing Overview Images

(71) Applicant: Carl Zeiss Microscopy GmbH, Jena (DE)

(72) Inventors: Manuel Amthor, Jena (DE); Daniel Haase, Zoellnitz (DE)

(21) Appl. No.: 18/102,168

(22) Filed: Jan. 27, 2023

(30) Foreign Application Priority Data
Jan. 31, 2022 (DE) 10 2022 102 219.6

(51) Int. Cl. G06T 11/60; G06T 7/60; G06V 30/14; G06T 3/60; G02B 21/36

(52) U.S. Cl. CPC G06T 11/60; G06T 7/60; G06V 30/1448; G06T 3/60; G02B 21/365

(57) ABSTRACT

In a computer-implemented method for editing overview images of a microscope, a raw overview image is obtained in a first step. The raw overview image is transformed by means of calibration data into an overview image in which image directions coincide with given directions. At least one geometric property of text of at least one text region in the overview image is determined. A transformed text region is calculated taking into account the determined geometric property so that the transformed text region exhibits a desired geometric property of the text.

### REFERENCE TO RELATED APPLICATIONS

The current application claims the benefit of German Patent Application No. 10 2022 102 219.6, filed on 31 Jan. 2022, which is hereby incorporated by reference.

### FIELD OF THE DISCLOSURE

The present disclosure relates to a microscopy system and a method for editing overview images of a microscope.

### BACKGROUND OF THE DISCLOSURE

Modern microscopes often comprise an additional overview camera for generating overview images of a sample carrier. The overview camera is provided in addition to a sample/system camera that can capture sample images at a higher magnification via a microscope objective. An overview image can be used, e.g., as a navigation map via which a user can control or carry out an adjustment of a sample stage relative to the optical path of the microscope. For example, directional controls can be entered via a joystick or using arrow keys displayed on a computer screen in order to move a motorized sample stage. An orientation of the overview image should be in line with these directional controls. For example, if the joystick is tilted to the right or an arrow key “right” is selected, then the thereby commanded sample stage adjustment should also bring about a shift of the sample stage or optical axis to the right in the overview image and not, for example, a shift in an upward or diagonal direction. An orientation of the overview image should also ideally coincide with an orientation of sample images captured using the sample camera. For example, if a sample structure is located to the left of another structure in a sample image, then that sample structure should ideally also appear to the left of said other structure in the overview image. Such a desired orientation is often not found in raw overview images as obtained by an overview camera. To remedy this, it is in particular possible to carry out a transformation of a raw overview image in order to calculate an overview image in which image directions coincide with fixed directions, e.g., with image directions in sample images or with the movement direction commands that can be specified for a sample stage per joystick, trackball or arrow keys. The transformation of the raw overview image occurs using calibration data established in a calibration process. For the calibration, it is possible, e.g., to capture and compare a plurality of raw overview images at different, known sample stage positions. It is also possible to capture one or more raw overview images and sample images of the same (calibration) sample in order to establish how an orientation of the (calibration) sample differs between raw overview images and sample images. If an overview camera views the sample stage or a sample carrier on the sample stage at an oblique angle, it is also possible to use the calibration data to carry out a transformation from an oblique view to a top view.

With respect to the calibration of a camera of a microscope, reference is made to the following prior art: US 2007/0 211 243 A1 as well as the Applicant's publications DE 10 2017 111 718 A1, U.S. Pat. No. 9,344,650 B2, DE 10 2019 114 117 B3 and DE 10 2013 012 987 A1 respectively disclose a calibration by means of a reference object, wherein calibration data is subsequently used to process captured images. A microscope with which overview images of a calibrated overview camera are assessed was disclosed by the Applicant in DE 10 2017 109 698 A1. In DE 10 2013 222 295 A1, the Applicant described a calibration method for a microscope with a swivel stand by means of which an autofocus and image center tracking are rendered possible. An assessment of an overview image in particular in order to establish and automatically set a sample position was described by the Applicant in DE 10 2013 006 994 A1. In DE 10 2020 101 191 A1, the Applicant described an assessment of overview images of a microscope involving the establishment of a homography by means of which the overview image is transposed into another representation; the establishment of the homography exhibiting the correct perspective can by carried out, inter alia, with images of calibration samples of known measurements.

Depending on the design of the microscope, the overview camera and the sample camera can view a sample carrier from different sides; for example, the sample camera can view an underside of the sample carrier while the overview camera views a top side of the sample carrier. In particular in such cases, the transformation by means of which the overview image is calculated from the raw overview image can involve image mirroring. It can thereby be achieved that image directions in the overview image and in the sample image coincide and are not reciprocally mirror-reversed. However, in particular as a result of the transformation of the raw overview image, it can occur that text on, e.g., a label of the sample carrier appears mirror-reversed and is difficult to read. This problem can also occur when there is no mirroring of the raw overview image, in particular when the overview camera captures text located on the opposite side of a transparent sample carrier, e.g., such as lettering on glass slides. As a result, a legibility of text on a sample carrier in overview images can be impeded.

### SUMMARY OF THE DISCLOSURE

It can be considered an object of the invention to indicate a microscopy system and a method which enable a high image quality and an improved legibility of text in overview images of a microscope.

This object is achieved by means of the method with the features of claim 1 and by means of the microscopy system with the features of claim 16.

In a computer-implemented method for editing overview images of a microscope according to the invention, a raw overview image, in particular of a sample carrier, is obtained by means of an overview camera of a microscope. The raw overview image is transformed by means of calibration data in order to calculate an overview image in which in particular image directions coincide with fixed directions. At least one geometric property of text of at least one text region in the overview image is established. A transformed text region is calculated taking into account the established geometric property so that a desired geometric property of the text occurs in the transformed text region.

A microscopy system according to the invention includes a microscope for acquiring images, in particular comprising an overview camera for capturing an overview image and a sample camera for capturing sample images. The microscopy system further comprises a computing device which is configured to carry out the method according to the invention.

A computer program according to the invention comprises commands that, when the program is executed by a computer, cause the computer to execute the method according to the invention.

The transformation of the text region or transformations of the text regions do not affect the entire overview image but only the sections of the overview image in which text was established. The text regions are thus modified vis-à-vis a remaining image content of the overview image, e.g., rotated, mirrored or altered in perspective. It is thereby possible to simultaneously achieve the goals of providing an overview image in the desired orientation and displaying text in an improved image quality, i.e. making text easier to read for a human or software. The transformation of the text region in particular allows a compensation of orientation issues of the text region resulting from the transformation of the raw overview image using the calibration data. At the same time, the thus edited overview image can still serve as a map for sample navigation.

### Optional Embodiments

Variants of the microscopy system according to the invention and of the method according to the invention are the object of the dependent claims and are explained in the following description.

### Text Region

A text region in the overview image can designate the text pixel-exactly or, alternatively, can designate a text with a surrounding area. For example, the text region can be a sticker, label or labelling field on a sample carrier. In principle, the text or text region can also occur on objects other than a sample carrier. It is also possible for one or more sample carriers to be partially or entirely visible in the overview image, wherein a plurality or all of the visible sample carriers exhibit a text region. The text can be printed or handwritten and can comprise in principle any characters, e.g., numbers and/or letters. The text can also comprise machine-readable characters, for example a barcode or a 2D barcode, or image elements such as logos. A text region does not necessarily have to be located in areas specially designated for the same on the sample carrier (e.g., areas comprising paper or frosted glass). Instead, a text region can consist in, for example, a text written directly on the glass of a sample carrier.

### Geometric Properties and Text Regions Transformed Via Geometric Properties

It can be established as a geometric property of the text whether the text in the overview image is mirror-reversed. A mirror-reversed orientation is understood to mean that characters of the text, e.g. numbers or letters, are mirrored horizontally or vertically so that, e.g., the characters “Eb” are displayed as “d∃” or an “A” is displayed as “∀”. Should it be detected that the text is mirror-reversed, the calculation of the transformed text region comprises a mirroring of the text region. This yields the desired geometric property that a mirror-reversed text orientation does not occur in the transformed text region. Optionally, a distinction is made between vertical and horizontal mirroring, although a vertical mirroring can also be implemented by way of a horizontal mirroring and a rotation by 180°, or vice versa. The mirroring affects alone the text region, which is thus mirrored relative to other image content of the overview image.

It is additionally or alternatively possible to establish a rotational orientation as a geometric property of the text. A rotational orientation can be understood as an angle of rotation at which characters of the text are arranged relative to an axis of the overview image (for example relative to an edge of the overview image). The calculation of the transformed text region can comprise a rotation of the text region relative to adjacent image content. The rotation yields the desired geometric property of the transformed text region in the form of a certain rotational orientation of the text. In cases where the text in the overview image is upside down so that, e.g., the characters “through” appear as “ [symbol] ”, there can occur a rotation by 180° or, more generally, by 160°-200°. If the text runs vertically, it is optionally possible to carry out a 90° rotation so that the text runs horizontally in the transformed text region. Potentially interfering minor rotations, for example lying between 1° and 20°, can be compensated so that the text in the transformed text region in particular runs parallel to an image edge or sample carrier edge.

It is further additionally or alternatively possible to establish a perspective distortion as a geometric property of the text. For example, the calculation of the overview image from the raw overview image can be carried out by means of a homography estimation with which an oblique view is transformed into a top view. A transformation that results in a correct perspective, however, is only possible for a plane at a certain distance while image content of planes at any other distance is distorted. The transformation of the raw overview image can thus also cause a perspective distortion of text. The calculation of the transformed text region now includes a perspective rectification of the text region to remove distortion. For example, a rectangle deformed into a trapezoid can be understood as a distortion, i.e. a structure on the sample carrier that is in fact rectangular is depicted as a trapezoidal structure in the overview image. A perspective rectification represents the inverse process to the established distortion and can thus comprise the deformation of a trapezoid into a rectangle. This yields the desired geometric property in the form of the depiction of text in the transformed text region without distortion or at the very least with less distortion than in the overview image.

Should a plurality of text regions be established in the same overview image, geometric properties can be captured separately for each text region and each text region can be transformed independently of other text regions. This can be advantageous, e.g., when a distortion varies over the overview image or when one text region is upside down relative to another text region. It is alternatively possible to provide a uniform transformation for all text regions so that, e.g., all text in the overview image is rotated by the same angle. This ensures that a plurality of related text fields, for example row/column identifiers “A B C . . . ” of a microtiter plate, retain a correct orientation in relation to one another. In this example, the row/column identifiers are identified as separate text fields through the spacing of the characters so that “A”, “B” and “C” are each transformed separately. Each text field retains its position in the overview image and is merely, e.g., rotated, mirrored or altered in perspective.

### Additional Quality Enhancement of Text Regions

In addition to geometric properties, it is also possible to establish further properties of a text region in order to modify the text region accordingly without modifying other image content.

For example, it is possible to check whether the text satisfies a minimum size (in particular in pixels). If this is not the case, the text is enlarged relative to surrounding image content. As a result of this scaling, the text is depicted larger than its actual size on the sample carrier.

Additionally or alternatively, it is possible to check whether an image property in the text region—in particular a text definition, a brightness, a contrast, a tone value, a gamma value and/or a color—meets predetermined criteria. If the criteria are not met, a modification of the corresponding image property in the text region can be carried out (relative to surrounding image content).

Additionally or alternatively, it is possible to check whether there is a partial concealment or shading of text. Concealment or shading can be caused, e.g., by the sample carrier or by a holding frame. In the event that a partial concealment is determined, it is possible for characters to be added to the text by means of a machine-trained model. The same applies in cases of a shading that renders shaded characters indistinguishable. If characters are still distinguishable in the event of a shading, a uniform representation of the characters inside and outside the shaded area can be achieved by suitable changes in color, brightness and contrast.

It is further possible to check whether there is a smearing of text. Smearing can in particular occur in the event of written text on glass slides. Should a smearing be detected, an automatic image processing for the removal of smearing can occur.

### Calculating a Transformed Text Region

The transformed text region can be calculated by transforming—in particular mirroring and/or rotating—the text region established in the overview image relative to a remaining image content of the overview image.

Alternatively, characters of the text in the text region of the overview image can be identified by means of optical character recognition (OCR). The transformed text region can then be generated by replacing the text with newly generated characters corresponding to the characters identified by means of OCR but differing in their arrangement so as to satisfy the desired geometric property. Should, for example, upside-down text be detected in the overview image and the characters constituting the text are identified by OCR, then these characters can be regenerated in a specified font and rotated 180° relative to the original text in the overview image. The text font, size and color can optionally be automatically chosen from different selectable options so as to be as similar as possible to the original text in the overview image. Described variant embodiments in which the text/text region is deformed can be modified so as to comprise the addition of newly generated text which corresponds in orientation to the described transformed text region.

The newly generated characters generated by OCR can be saved in the overview image as an additional text layer in order to enable further machine-readable text processing. OCR and an additional text layer can also be implemented in the other described variants. If, for example, row/column identifiers of a multiwell plate (e.g., A1, B8, etc.) are saved in the form of a text layer, it becomes possible during a subsequent selection and analysis of a plurality of wells of the multiwell plate for the row/column identifier of the respective well under analysis to be identified per automatic text processing and saved together with captured sample images.

### Display of the Transformed Text Region

The text region in the overview image can be replaced by the transformed text region. Alternatively, the transformed text region can be saved or displayed on a screen in addition to the overview image containing the untransformed text region. This ensures that potentially irritating image artefacts do not occur within the overview image because of a transformation, while still improving the legibility of text by means of the separately displayed transformed text region.

### Inpainting

The transformed text region can have a different size or shape than the original text region. Gaps can thus occur when the text region is replaced by the transformed text region. A gap denotes pixels of the overview image which belong to the text region to be replaced but which are not filled by the transformed text region on account of the shape and size of the latter. The gap can be filled by means of a model trained for image reconstruction, also referred to as an inpainting model. The model is trained to fill a gap or a selected area in an input image using other content of the input image.

Inpainting can also facilitate an embedding of the transformed text region in the overview image. A soft transition can be generated for a boundary between the transformed text region and an adjacent image content of the overview image by inputting the overview image with the transformed text region into an inpainting model (a model trained for image reconstruction). The model modifies or replaces an image area around the boundary between the transformed text region and the adjacent image content. It can be stipulated for the model that only image pixels around the boundary are to be replaced while the remaining image areas should remain unchanged.

It can also be provided that the text in the overview image is first removed by means of a model trained for image reconstruction and that the transformed text region is only inserted thereafter. This has the advantage of preserving a background structure, for example a pattern or a color/brightness gradient around a text. If, for example, a mirror-reversed text is replaced with a mirrored text with a correct orientation, the surrounding color or brightness gradient is not changed as a result. An initial pixel-exact segmentation of the mirror-reversed text in the overview image can be carried out here. The text is then removed pixel-exactly by means of inpainting using adjacent image content. A mirrored (i.e. correctly oriented) text is subsequently inserted as the transformed text region at the same location in the overview image. In particular in this example, the text region can denote just the pixels of the text, without surrounding pixels.

### Calibration Data for Transforming Images and Resulting Image Directions

Calibration data can be predetermined and be obtained in a manner known per se. The calibration data can define or help to determine how an oblique view is converted into a top view through the transformation of the raw overview image and/or whether an image mirroring is required for the calculation of the overview image.

The transformation of the raw overview image can be based on a homography estimation and/or involve a perspective distortion of the raw overview image. A homography or homography estimation allows a plane in space to be mapped or projected into another plane. The homography estimation thus describes how an image content (of the raw overview image) would be seen from another perspective.

As explained in the introduction, it can be achieved by means of the transformation of the raw overview image that image directions subsequently correspond to fixed directions. The fixed or given directions can be essentially arbitrary and can relate to, e.g., image directions in sample images and/or directions of selectable movement commands/control commands for an adjustable sample stage.

A control command in a certain direction can thus bring about an adjustment between an optical axis and the sample/sample carrier in the same direction in the overview image. The adjustment can be carried out by means of a motorized sample stage. The control command can be selected via software or via a control element on the microscope or an input device connected to the microscope. For example, the control element can comprise a joystick, a trackball, arrow keys of a computer keyboard or other keys or touchscreen areas. If, for example, there occurs an input “to the left” via the trackball, then the commanded adjustment of the sample stage should also bring about an adjustment in the overview image in the same direction. The adjustment in the overview image can relate, for example, to an adjustment between an optical axis and the sample or to an adjustment between the sample stage and a stationary reference point. The movement axes of a manually adjustable sample stage also ideally coincide with image directions in the overview image. As mentioned above, it is alternatively or additionally possible for the fixed directions to further be defined by image directions in sample images captured by a sample camera different from the overview camera. Depending on rotational settings and the viewing directions of the overview camera and the sample camera, image directions can be the same or different in the corresponding captured images. The transformation of a raw overview image by means of calibration data can optionally occur so that image directions in the overview image are subsequently identical with the image directions in sample images.

The calibration data can also be used to establish the geometric property and/or for the calculation of the transformed text region. For example, it is possible to take into account whether a mirroring occurred according to the calibration data or the transformation of the raw overview image carried out with said calibration data. In this case, there can be an increased likelihood or it can be known that text in the overview image is mirror-reversed. In particular in this example, the establishment of a geometric property of text can also occur exclusively on the basis of the transformation carried out with the calibration data so that a corresponding evaluation of the overview image is superfluous. For the calculation of the transformed text region, the calibration data can in particular be used to reverse any mirroring for the text region.

### Contextual Information

It is also possible to take into account contextual information in the described processes. Contextual information can in particular be used in a localization of text regions in the overview image, in the establishment of a suitable transformation of a text region and/or in a further processing of the (transformed) text region for image quality enhancement, for example in a modification of the contrast or brightness of the text region.

The contextual information can comprise particulars regarding a microscope user. Different users can have different routines when labelling sample carriers so that it is possible to store contextual information for different users regarding what kind of labelling is likely to occur at which location or in which orientation on the sample carrier.

Contextual information can also comprise particulars regarding a sample type and/or sample carrier type in use, microscope components in use, environmental parameters such as room lighting, or particulars of a working environment (e.g., whether the microscopy system is located in a laboratory or factory). In order to be exploitable, contextual information can be entered, for example, in the training of a machine-learned model together with an input image to be processed. If the model is intended to find, e.g., text regions in the form of labelling fields/labels, the input image can be an overview image and a segmentation, e.g. a binary mask, in which labelling fields/labels are designated is specified as the target image (ground truth). The model thus learns to establish the location of a labelling field from an input overview image. If an indication of a sample carrier type is also provided as contextual information in the training, the model learns to take this information into account when establishing the location of a labelling field. Different sample carriers can differ, e.g., with respect to the size, shape, arrangement and/or color of labelling fields.

### General Features

The raw overview image can be an unprocessed raw image of the overview camera. Alternatively, the raw overview image can also be generated from one or more raw images of the overview camera, for example by cropping a raw image, combining a plurality of raw images of different image brightnesses, or by modifying image properties such as brightness, contrast or tone value.

The overview camera can be arranged on a microscope stand. If the microscope in question is a light microscope, the overview camera is provided in addition to a sample camera, which captures sample images at a higher magnification than the overview camera. In principle, it is also possible for sample images to be generated by other types of microscopes, for example by electron microscopes, X-ray microscopes or atomic force microscopes. A microscopy system denotes an apparatus which comprises at least one computing device and a microscope.

The computing device can be designed in a decentralized manner, be physically part of the microscope or be arranged separately in the vicinity of the microscope or at a location at any distance from the microscope. It can generally be formed by any combination of electronics and software and comprise in particular a computer, a server, a cloud-based computing system or one or more microprocessors or graphics processors. The computing device can also be configured to control microscope components.

Text captured in an overview image can be located on one or more objects of in principle any kind, in particular on sample carriers. A sample carrier can be a support or vessel for one or more samples, e.g., a microtiter plate with a plurality of sample wells, a chamber slide with a plurality of in particular rectangular sample receptacles, a Petri dish with one or more separate sample arrangement areas or a transparent slide with a cover slip. An analyzed sample can generally take any form and can comprise, for example, biological cells or cell parts, tissue sections, material samples or rock samples, electronic components and/or objects held in a liquid.

Method variants can optionally comprise the capture of at least one raw overview image by the microscope while in other method variants an existing raw overview image is loaded from a memory.

Descriptions in the singular are intended to cover the variants “exactly 1” as well as “at least one”. Descriptions according to which a text region is established or transformed are intended to comprise, for example, the possibilities that exactly one or at least one text region is established or transformed.

Described image processing or image calculations can be carried out by means of software, in particular partially or completely by means of machine-learned models executed by the computing device. The transformations of text regions as well as the inpainting variants, inter alia, can respectively be calculated by learned models, in particular by models for image-to-image mapping. The establishment of geometric properties can also occur by means of a learned model designed, e.g., for image classification, detection or regression.

Learned models generally denote models that have been learned by a learning algorithm using training data. The models can comprise, for example, one or more convolutional neural networks (CNNs), which receive as input at least one image, e.g., text regions, the overview image or sections thereof. A learning algorithm uses training data to define model parameters of the machine learning model. A predetermined objective function can be optimized to this end, e.g. a loss function can be minimized. The model parameter values are modified to minimize the loss function, which can be calculated, e.g., by gradient descent and backpropagation. Other deep neural network model architectures are also possible.

The characteristics of the invention that have been described as additional apparatus features also yield, when implemented as intended, variants of the method according to the invention. Conversely, a microscopy system or in particular the computing device can also be configured to carry out the described method variants.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 schematically shows an example embodiment of a microscopy system of the invention;

FIG. 2 schematically shows processes of an example embodiment of a method according to the invention;

FIG. 3 schematically shows processes of a further example embodiment of a method according to the invention;

FIG. 4 shows a flowchart of an example embodiment of a method according to the invention.

### DETAILED DESCRIPTION OF EXAMPLE EMBODIMENTS

Different example embodiments are described in the following with reference to the figures.

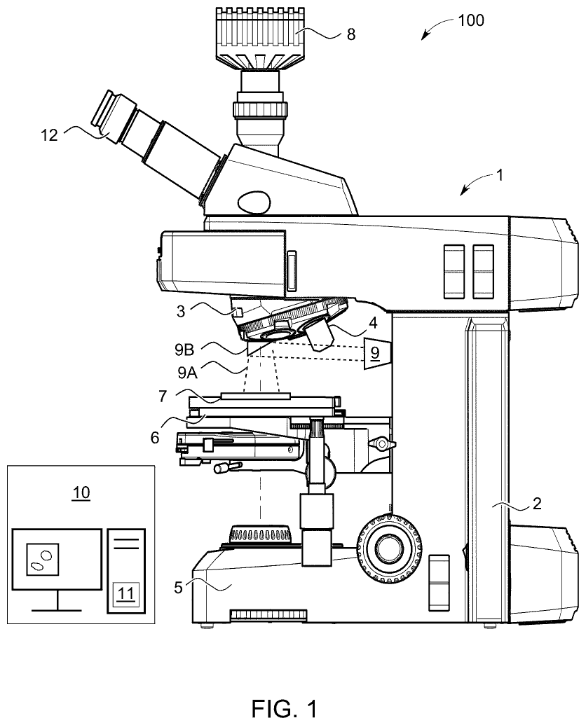

### FIG. 1

FIG. 1 shows an example embodiment of a microscopy system 100 according to the invention. The microscopy system 100 comprises a computing device 10 and a microscope 1, which is a light microscope in the illustrated example, but which in principle can be any type of microscope. The computing device 10 comprises a computer program 11 stored on a data carrier for processing a microscope image according to a method according to the invention. The microscope 1 comprises a stand 2 via which further microscope components are supported. The latter can in particular include: an illumination device 5; an objective changer/revolver 3, on which an objective 4 is mounted in the illustrated example; a sample stage 6 with a holding frame for holding a sample carrier 7; and a sample camera 8. When the objective 4 is pivoted into the light path of the microscope, the sample camera 8 receives detection light from a sample area in which a sample can be located in order to capture a sample image. A sample can be any object, fluid or structure. In addition to or instead of the sample camera 8, it is also possible to use an eyepiece 12 for the generation of a sample image. The microscope 1 comprises an additional overview camera 9 for capturing an overview image, i.e. a raw overview image, of a sample environment. A field of view 9A of the overview camera 9 is larger than a field of view when a sample image is captured. In the illustrated example, the overview camera 9 views the sample carrier 7 via a mirror 9B. The mirror 9B is arranged on the objective revolver 3 and can be selected instead of the objective 4. In variants of this embodiment, the mirror is omitted or a different arrangement of the mirror or some other deflecting element is provided.

In the example shown, the overview camera 9 views the sample stage 6 from above and thus views a top side of a sample carrier 7 arranged there. Alternatively, the overview camera 9 can also be arranged so as to view the sample stage 6 from below and thus view an underside of a sample carrier 7. In the example shown, the sample camera 8 views the sample carrier 7 from above, although it is alternatively also possible for it to view the sample carrier 7 from below in an inverted arrangement. The sample camera 8 and the overview camera 9 can in particular also be pointed at the sample carrier 7 from different sides. Depending on the arrangement of the overview camera 9, it can be preferable to mirror captured raw overview images so that image directions coincide with fixed directions, e.g., so that, for a user in front of the microscope, the directions left and right coincide with the image directions left and right and are not reversed. Although image mirroring can be advantageous for the orientation of a user, it can in particular create issues for the legibility of text on the sample carrier 7, as described in greater detail with reference to the following figures.

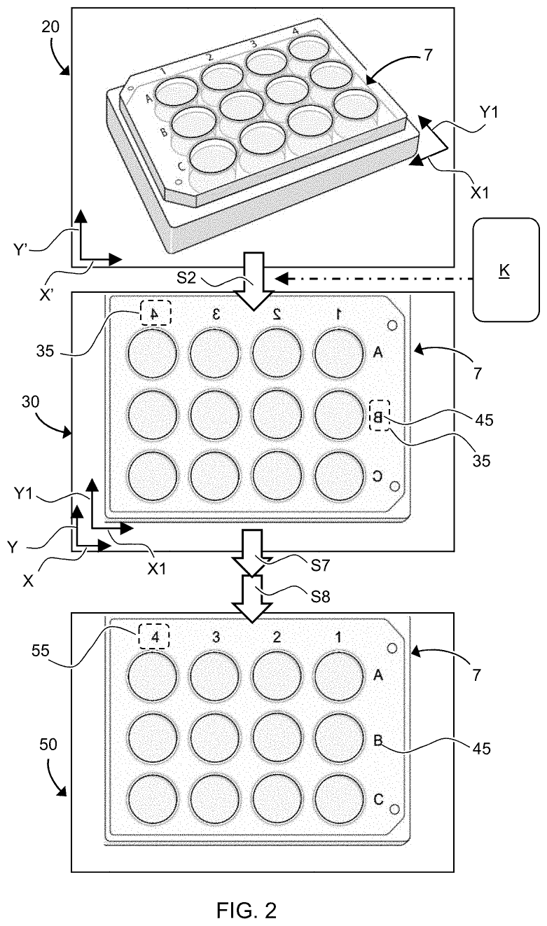

### FIG. 2

FIG. 2 schematically shows processes of a method according to the invention. A schematically illustrated raw overview image 20 has been captured by means of an overview camera. The raw overview image 20 is an oblique view of a sample carrier 7, which is a microtiter plate in the illustrated example. Image directions X′ and Y′ of the raw overview image 20, e.g. its horizontal and vertical directions, ideally coincide with given directions X1 and Y1, which is not the case here. The directions X1 and Y1 can relate to, e.g., directions of the sample stage as seen by a user in front of the microscope. Additionally or alternatively, an overview image ideally exhibits a top view instead of an oblique view. A top view denotes a viewing direction perpendicular to the sample stage while in an oblique view a viewing direction forms an angle with the perpendicular to the sample stage.

In a step S2, the raw overview image 20 is transformed, whereby an overview image 30 is obtained. The transformation can take the form of, e.g., a homography estimation by means of which it is calculated or estimated how a plane in space is seen from a different angle. The sample stage surface or a plane parallel to it can be assumed as the plane. Calibration data K are used for the transformation. The calibration data K depend on a position and orientation of the overview camera and any optical elements located in the optical path of the overview camera, e.g. mirrors. The transformation for calculating the overview image 30 can also occur by means of other mathematical operations, which can in particular comprise a distortion (different modifications of image width and image height), a rotation and/or a mirroring.

In the illustrated example, the calculated overview image 30 corresponds to a top view of the sample carrier 7. Image directions X, Y of the overview image 30 coincide with the directions X1, Y1. The directions X1, Y1 can also be called microscope directions or fixed/given directions. In order to form the overview image 30, the raw overview image 20 was, inter alia, mirrored. Mirroring can in particular be appropriate when the overview camera and the sample camera view the sample or sample carrier 7 from different sides so that an image direction to the right in the overview image approximately coincides with an image direction to the right (and not to the left) in an image captured by the sample camera.

As a result of the mirroring, however, text 45 on the sample carrier 7 is depicted mirror-reversed in the overview image 30. A mirror-reversed representation can occur in other cases too, e.g., when a transparent sample carrier area includes text on its rear side as seen from the overview camera.

In the illustrated example, the overview image contains text 45 in separate areas (A, B, C, 1-4) indicating a column and row numeration of wells of the sample carrier 7.

Respective text regions 35 containing text 45 are identified by means of image analysis. The text regions 35 can either match the shape of the text 45 as exactly as possible, i.e. outline the text 45 ideally pixel-exactly, or contain a surrounding area around the text 45 as illustrated. The identified text regions 35 are analyzed by means of image analysis in order to establish geometric properties of the text 45, e.g., an orientation of the text 45, a text size in pixels, a character distortion, or an indication of whether the text 45 is displayed mirror-reversed. In the illustrated example, the image analysis reveals that the text 45 is displayed mirror-reversed in each instance. In step S7, transformed text regions 55 are calculated from the text regions 35 and, in step S8, the text regions 35 are replaced by the transformed text regions 55, whereby an edited overview image 50 is obtained. The established geometric properties, in this example the knowledge that the text is mirror-reversed, are used to calculate the transformed text regions 55. The transformed text regions 55 are thus calculated via a mirroring of the respective text regions 35. As a result, a desired geometrical property, namely the absence of a mirror-reversed representation, is provided in the transformed text region 55.

As a result of the transformation carried out with the calibration data K, the edited overview image 50 is suitable to act as a navigation map that a user can use to select a sample receptacle or sample area to be analyzed. At the same time, text 45 in the edited overview image 50 is easy to read for a user or software-based OCR.

A similar method variant is described in the following with reference to the next figure.

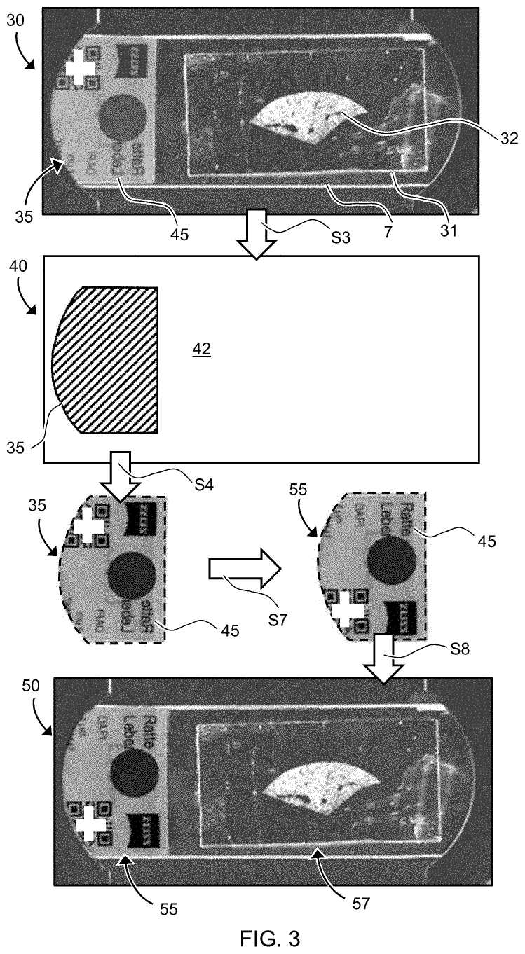

### FIG. 3

Processes of a further example embodiment of a method according to the invention are shown in FIG. 3.

The illustrated overview image 30 is—with the exception of changes in brightness and contrast and the suppression of the 2D barcode—an actual example of an overview image calculated from a raw overview image of an overview camera using calibration data. The overview picture 30 shows a sample carrier (transparent slide) 7 with a sample 32 and a cover slip 31. The sample carrier 7 further comprises a label on which a text 45 is printed, e.g., regarding the sample type and sample preparation.

In step S3, there occurs a segmentation of the overview image 30 by means of a machine-learned (segmentation) model trained to localize a text region 35 in an overview image 30. An output of the segmentation model is a binary mask or segmentation mask 40 in which one pixel value indicates pixels belonging to the text region 35 while another pixel value designates an image area 42 that is not a text region. In this example, the segmentation model has been trained to identify labels as text regions 35 so that not only the characters per se but also surrounding pixels form part of the identified text region 35. Depending on training data, the segmentation model can be trained to only identify labels that actually contain characters as text regions 35 or to only identify sections of labels as text regions 35. The segmentation model can in particular be an instance segmentation model which distinguishes different text regions 35 from one another even when they touch or overlap. An instance segmentation model can output a plurality of binary masks or a segmentation mask with more than two different pixel values. Instead of a segmentation model, it is also possible to use a detection model to localize or determine text regions 35.

In step S4, the text region 35 of the overview image 30 localized by means of the segmentation mask 40 is extracted. An analysis and modification of the image brightness and contrast has also already been carried out in order to enhance a contrast of characters vis-à-vis a background. The text region 35 is analyzed with regard to geometric properties of its text 45, a mirror-reversed text representation being determined in this example. In step S7, a mirroring of the text region 35 is carried out in order to form a transformed text region 55. In step S8, the text region 35 is replaced by the transformed text region 55, whereby an edited overview image 50 is obtained.

In the illustrated example, a shape of the text region 35 is not exactly mirror-symmetrical. It is thus not possible for the transformed text region 55 to replace all image pixels of the text region 35 exactly, i.e. without gaps. If the segmentation is not perfect, it is also possible for edges or frames to occur, for example when an identified text region 35 includes not only the brighter label but also pixels from the darker area surrounding the label. An inpainting is accordingly employed in which a machine-learned model (reconstruction or inpainting model) realistically fills in gaps or flaws in an input image using other content in the image. It is possible to designate for the input image which image areas are to be filled in via inpainting. The input image in question can be the overview image including the transformed text region 55, wherein a boundary area is designated between the transformed text region 55 and the adjacent content of the overview image and modified accordingly by the inpainting model. The inpainting model can thus both fill in gaps and compensate artefacts of an imperfect segmentation.

The image processing in step S7 only relates to the text region and leaves image content 57 outside the text region (or outside the text regions in cases where a plurality of text regions are established) unchanged. As a result, text regions 55 and other image content 57 are thus transformed differently, in particular rotated, mirrored, distorted and/or rescaled differently relative to each other.

Further method variants are explained with reference to the following figure.

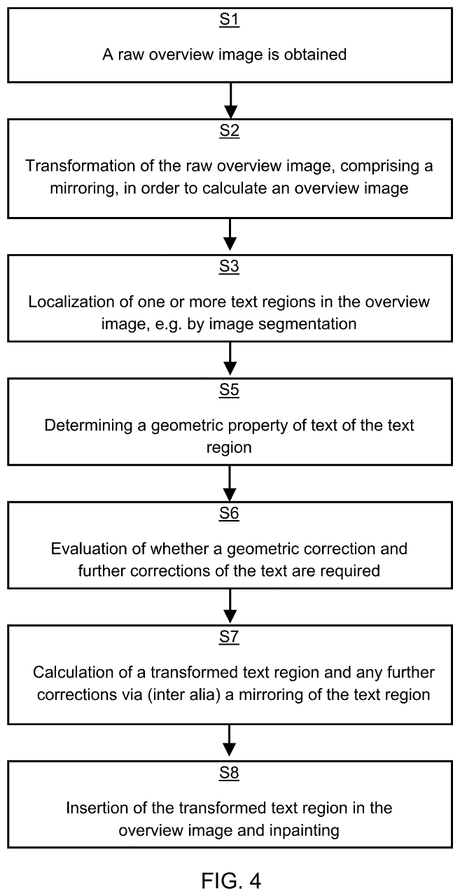

### FIG. 4

FIG. 4 shows a flowchart of processes of an example embodiment of a method according to the invention.

In step S1, a raw overview image is obtained, e.g., captured by an overview camera or loaded from a memory. It is optionally also possible for raw data of the overview camera to have been pre-processed in order to generate the raw overview image.

In step S2, the raw overview image is transformed, which involves an image mirroring in the illustrated example, in order to form an overview image. Additionally or alternatively to the image mirroring, a rotation, a perspective distortion or a mapping onto another plane, e.g. in the form of a homography estimation, can also occur.

In step S3, the overview image is analyzed in order to localize text regions. This can occur, e.g., with an image segmentation model trained for this purpose. Depending on training data, the model can be trained to segment text pixel-exactly, to always segment text with surrounding pixels, or to segment areas (e.g. labels) that potentially contain text.

In step S5, geometric properties of the text in the text region or areas are established. This analysis can be carried out based on the entire overview image or based on the text regions only. It can be advantageous to take into account the entire overview image, e.g., when a text orientation can be detected via a sample carrier orientation. This can be the case, for example, with microtiter plates on which the text serves to identify the individual sample receptacles. The establishment of a geometric property can be carried out by means of a model trained for this purpose. The model can be learned, e.g., using training data showing respective image data of text and comprising as a target result an associated (e.g. manually specified) piece of geometric information, e.g. an indication of whether the text is displayed mirror-reversed or not. It is also possible to implement a model trained for OCR.

In step S6, it is evaluated whether a geometric correction of the text is required. Optionally, it is further evaluated whether further corrections of the text are required. To this end, e.g., the established geometric properties and optionally other established properties (e.g., image brightness, contrast or image definition of the text region) can be compared with predetermined criteria.

Depending on the outcome of the evaluation in step S6, the text region or areas are changed or transformed accordingly in step S7 so that a desired (geometric) property occurs in the text regions. The changes only relate to text regions so that, for example, text is displayed in a higher definition and a higher contrast while avoiding the risk that other image content appears unrealistic due to, e.g., an increased contrast.

In step S8, the at least one transformed text region is inserted into the overview image. Optionally, an inpainting can occur as described. In variants, an inpainting is implemented to remove text from the overview image calculated in S2. This is appropriate when the localization of text regions in S3 identifies characters as pixel-exactly as possible, i.e. without surrounding pixels or barely including surrounding pixels. These localized text regions can be replaced by means of inpainting in order to create a text-free background. Inpainting preserves a background structure, for example a pattern or brightness gradient on a label. The transformed text region in this example comprises the characters pixel-exactly and can now be inserted in the overview image modified by inpainting.

An order of the described steps can vary. For example, the inpainting for removing text can occur before or in parallel with the execution of the steps S5 and S6.

In an alternative to step S8, the transformed text region can also be displayed next to the overview image as calculated in S2. This likewise allows an improved legibility of the text while simultaneously providing a suitable orientation and perspective of the overview image.

The variants described in relation to the different figures can be combined with one another. The described example embodiments are purely illustrative and variants of the same are possible within the scope of the attached claims.

### LIST OF REFERENCE SIGNS

1 Microscope
2 Stand
3 Objective revolver
4 (Microscope) objective
5 Illumination device
6 Sample stage
7 Sample carrier
8 Sample camera
9 Overview camera
9A Field of view of the overview camera
9B Mirror
10 Computing device
11 Computer program
12 Eyepiece
20 Raw overview image
30 Overview image
31 Cover slip
32 Sample
35 Text region of an overview image which contains characters
40 Segmentation mask for the localization of text regions
42 Areas of a segmentation mask that do not designate a text region
45 Text of a text region
50 Edited overview image containing at least one transformed text region
55 Transformed text region
57 Image content outside text regions
100 Microscopy system
K Calibration data
S1-S8 Steps of example embodiments of methods according to the invention
X, Y Image directions in the overview image
X′, Y′ Image directions in the raw overview image
X1, Y1 (Fixed/given) directions

What is claimed is:

1. A computer-implemented method for editing overview images of a microscope, comprising:
obtaining a raw overview image of a sample carrier with an overview camera of a microscope;
transforming the raw overview image with calibration data in order to calculate an overview image in which image directions coincide with given directions;
determining at least one geometric property of text of at least one text region in the overview image;
calculating a transformed text region taking into account the determined geometric property so that a desired geometric property of the text occurs in the transformed text region.

2. The method according to claim 1,
wherein the calibration data define or help to determine how an oblique view is converted into a top view through the transforming of the raw overview image and whether an image mirroring is required for calculating the overview image.

3. The method according to claim 1,
wherein it is determined as a geometric property of the text whether the text is mirror-reversed,
wherein, in cases where the text is mirror-reversed, the calculating of the transformed text region comprises a mirroring of the text region so that a mirror-reversed text orientation does not occur in the transformed text region.

4. The method according to claim 1,
wherein a rotational orientation is determined as a geometric property of the text, wherein the calculating of the transformed text region comprises a rotation of the text region relative to adjacent image content so as to provide a certain rotational orientation in the transformed text region.

5. The method according to claim 1,
wherein a perspective distortion is determined as a geometric property of the text, wherein the calculating of the transformed text region comprises a perspective rectification of the text region.

6. The method according to claim 1,
wherein one or more of the following processes are carried out:
checking whether the text satisfies a minimum size, wherein the text is enlarged relative to surrounding image content in cases where the minimum size is not satisfied;
checking whether a text sharpness, a brightness, a contrast or a color tone in the text region meets predetermined criteria, wherein the text sharpness, brightness, contrast or color tone in the text region is modified in cases where the criteria are not met;
checking whether there is a partial concealment of text, in which case characters are added to the text with a machine-trained model;
checking whether there is smearing of text, in which case an image processing for removal of smearing occurs.

7. The method according to claim 1,
wherein calibration data is used in at least one of the determining of the geometric property and the calculating of the transformed text region.

8. The method according to claim 1,
wherein characters of the text in the text region are identified using optical character recognition (OCR) and
wherein the transformed text region is generated by replacing the text with newly generated characters corresponding to the characters identified with OCR but differing in their arrangement so as to satisfy the desired geometric property.

9. The method according to claim 8,
wherein the newly generated characters generated by OCR are saved in the overview image as an additional text layer in order to enable further machine-readable text processing.

10. The method according to claim 1,
wherein the transformed text region is saved or displayed on a screen in addition to the overview image containing the text region, or
wherein the text region in the overview image is replaced by the transformed text region.

11. The method according to claim 1,
wherein, in cases where the transformed text region has a different size or shape than the text region so that a gap occurs when the text region is replaced by the transformed text region, the gap is filled with a model trained for image reconstruction.

12. The method according to claim 1,
wherein a transition is generated for a boundary between the transformed text region and an adjacent image content of the overview image by inputting the overview image with the transformed text region into a model trained for image reconstruction, which modifies an image area around the boundary.

13. The method according to claim 1,
Wherein the text in the overview image is removed using a model trained for image reconstruction and the transformed text region is inserted thereafter.

14. The method according to claim 1,
wherein the transforming of the raw overview image is based on a homography estimation or involves a perspective distortion of the raw overview image.

15. The method according to claim 1,
wherein, using the calibration data, the transforming of the raw overview image for calculating the overview image occurs so that image directions in the overview image coincide with
an orientation of selectable directional commands for an adjustable sample stage, wherein the directional commands can be entered via software or a control element on the microscope, or
image directions in sample images captured by a sample camera different from the overview camera or image directions visible using a microscope eyepiece.

16. A microscopy system including
a microscope comprising an overview camera and a sample camera; and
a computing device configured to execute the method according to claim 1.

17. A computer program, comprising commands stored on a non-transitory computer-readable medium which, when the program is executed by a computer, cause the computer to execute the method according to claim 1.
